(19) United States
(12) Patent Application Publication
(10) Pub. No.: US 2005/0018961 A1
(43) Pub. Date: Jan. 27, 2005

(54) Element for transfer of light wave between optical components and the production method thereof

(76) Inventor: Serge Valette, Grenoble (FR)

Correspondence Address: PILLSBURY WINTHROP, LLP, P.O. BOX 10500, MCLEAN, VA, 22102, US

(21) Appl. No.: 10/480,286

(22) PCT Filed: Jun. 19, 2002
(86) PCT No.: PCT/FR02/02121

(30) Foreign Application Priority Data
Jun. 22, 2001 (FR) 01/08259

(51) Int. Cl. G02B 6/26

(52) U.S. Cl. 385/31; 385/39

(57) ABSTRACT

A transfer element has a first face and a second face. The first face is arranged facing a first optical component comprising at least one optical guide. The second face is arranged to face a second optical component. The transfer element is capable of transferring a light wave comprising one or several wavelengths, from one component to another. The transfer element is transparent to at least one wavelength of the light wave and has a refraction index greater than the largest of the effective indexes associated with the light wave when the light wave propagates in the first and in the second component. The transfer element also comprises at least one coupling/decoupling pattern on a first face positioned facing part of the optical guide. The pattern is separated from the first component by a distance d_{g1} less than a threshold distance dₛ₁ above which no light wave can be transferred from the first component to the transfer element and vice versa.

### CROSS-REFERENCE TO RELATED APPLICATIONS

This application is based on and claims priority to application no. 01/08259 Jun. 22, 2001 and application no. PCT/FR02/02121 filed Jun. 19, 2002 in France, the entire contents of each of which are hereby incorporated by reference.

### BACKGROUND OF THE INVENTION

1. Field of the Invention

This invention relates to an element for transferring a light wave between at least two optical components and the process for manufacturing this element. In particular, the element allows to couple and/or decouple a light wave propagating in a guide in an optical component.

2. Description of Related Art

Transfer of light between optical components usually creates a number of problems related to the dimensions of components and the precision alignment required between these components. For example, the alignment precision between components with dimensions of a few microns must be less than a micron.

Furthermore, optical components between which a light wave is transferred usually have very different geometries and refraction indexes. This also may lead to a number of problems of matching.

FIGS. 1a and 1b diagrammatically show a conventional method of transferring a light wave between 2 components.

These figures show two optical components reference 1 and 2. These optical components are provided with an optical guide 3 and an optical guide 5, respectively. The optical guides 3 and 5 may independently be either a microguide or a planar guide. The propagation profile 7 of the light wave in the guide 3 and the propagation profile 9 of the light wave in the guide 5 are shown schematically. Furthermore, the direction of propagation of the wave in these guides is indicated by an arrow.

As shown in FIG. 1a, the two components are arranged such that the optical output from the guide 3 is in line with the optical input of guide 5, in order to transfer light propagating in the guide 3 into the guide 5. Furthermore, to enable this transfer, faces of the two components facing each other must be prepared (for example by cleavage or by sawing followed by polishing). The faces are separated by a very small distance (less than few micrometers) to prevent diffraction losses.

FIG. 1b shows an approach similar to that shown in FIG. 1a but with an object-image conjugation element 11 placed between components 1 and 2. This approach provides additional freedom to adapt the geometry of associated components. However, the final structure is more complex and expensive to make.

FIG. 2 diagrammatically illustrates another method of transferring a light wave between two components, usually used in research.

In this example, one of the components is free space, in other words the incident light wave 13 is not guided. The other component 15 is an integrated optical component comprising a guide 17. A prism 19 is used to couple the incident light wave 13 in free space in the guide 17. This prism is pressed above the guide 17. An arrow P represents the pressure applied to the prism. Therefore, there is a very small space G between the base of the prism and the surface of the component 15.

The index nₚ of the material from which the prism is made and the angle θₚ between the base of the prism and the input face 21 of the prism are selected such that the incident wave 13 is in full reflection in the prism at the base of the prism. An evanescent wave 23 forms on the base of the prism that will excite the guide 17, the guide being very close to the prism. Thus, as the space G between the prism and the component decreases, the percentage of incident light coupled in the guide 17 increases. This transfer of light energy possibly reaching as high as 100%.

Unlike the examples shown in FIGS. 1a and 1b, this transfer method does not require any preparation of the input face of the light wave into the component 15. However, it is difficult to adapt this method for an industrial application due to problems in manufacturing the prisms, particularly with small dimensions, as well as in controlling the space G.

### BRIEF SUMMARY OF THE INVENTION

One aspect of an embodiment of the invention is to propose an element for transferring a light wave between at least two optical components which can easily be made reproducibly, particularly for an industrial application.

Another aspect of an embodiment of the invention is to propose a transfer element for associating optical components in order to make possibly complex optical functions.

Another aspect of an embodiment of the invention is to propose a transfer element that does not require any surface preparation and particularly any polishing.

To achieve these aspects, an embodiment of the invention uses a transfer element in which a first face is arranged facing a first optical component comprising at least one optical guide (first guide) and at least one second face which is arranged to face a second optical component. This transfer element is capable of transferring a light wave from one of the components to the other and vice versa. The light wave can comprise one or several wavelengths. According to the invention, the transfer element is transparent at at least one wavelength of the light wave and has a refraction index greater than the greatest of the effective indexes associated with the light wave at least for the wavelength, when the light wave propagates in the first and in the second optical components. The transfer element may also comprise at least one coupling/decoupling pattern on the transfer element's first face located facing a part of the first guide. The pattern (first pattern) is separated from the first component by a distance d_{g1} less than a threshold distance dₛ₁ above which no light wave can be transferred from the first component to the transfer element and vice versa through an evanescent wave.

An effective index is associated with each wavelength of the light wave propagating in a determined optical component, regardless of whether it is a guided optical component, i.e., a component comprising at least one optical guide, or an unguided optical component, for example free space such as air. One or several optical elements can be placed in the free space in which the light wave can propagate. In the latter case, the effective index corresponds to the index associated with the wave propagating in the free space.

The optical guide of the first component may equally be a planar guide or a microguide, i.e., a guide with lateral confinement.

The distance d_{g1} may be either constant or variable, but it is preferably less than the threshold distance dₛ₁.

Apart from the first coupling/decoupling pattern, the part of the first face that is facing the first guide, is at a distance h₁ from the first component. The distance h₁ is greater than or equal to the threshold distance dₛ₁ such that no light wave can be transferred from the first optical component to the transfer element through this part and conversely through an evanescent wave.

The value of the threshold distance dₛ₁ depends on the effective index(es) of the light wave guided in the first component, and also on the refraction index of the transfer element and the refraction index of the medium or media arranged between the transfer element and the first component. These media are transparent to the wavelength(s) of the light wave.

According to an embodiment of the invention, a medium chosen from a fluid such as air and/or a layer of material, for example silica, is placed between the transfer element and the first component. The refraction index of this medium is generally smaller than the smallest of the effective indexes associated with the light wave guided into the first component.

All or part of the light wave cannot be transferred from the first guide to the transfer element and vice versa by the first pattern, unless the first pattern has a sufficiently long “interaction length” Lᵢ₁. The maximum light wave, and in some cases the entire light wave, is transferred for an optimum interaction length Lₛ₁.

The value of the optimum length Lₛ₁ depends on dₛ₁.

According to an embodiment of the invention, the second component may equally be a guided optical component or an unguided optical component such as free space.

When the second component is an unguided optical component, the second face of the transfer element advantageously comprises an anti-reflection layer on at least the area of the face through which the light wave passes.

When the second component is a guided optical component comprising at least one optical guide (second guide), the transfer element also comprises at least one coupling/decoupling pattern on its second face, which face a part of the second guide. The pattern (second pattern) is separated from the second component by a distance d_{g2}. The distance d_{g2} is less than a threshold distance dₛ₂ above which no light wave can be transferred from the second component to the transfer element and vice versa, through an evanescent wave.

The optical guide of the second optical component may equally well be a planar guide or a microguide.

The distance d_{g2} may be constant or variable, but it is preferably less than the threshold distance dₛ₂.

Apart from the second coupling/decoupling pattern, the part of the second face facing the second guide is at a distance h₂ from the second component. The distance h₂ is greater than or equal to the threshold distance dₛ₂, such that no light wave can be transferred from the second component to the transfer element through the part of the second face and vice versa, through an evanescent wave.

The value of the threshold distance dₛ₂ depends firstly on the effective index(es) of the light wave guided in the second component, but may also depend on the refraction index of the transfer element and the refraction index of the medium or media located between the transfer element and the second component. These media are transparent to the wavelength(s) of the light wave.

According to an embodiment of the invention, a medium chosen from a fluid such as air and/or a material layer for example silica, is located between the transfer element and the second component. The refraction index of this medium is usually smaller than the smallest of the effective indexes associated with the light wave guided in the second component.

The second pattern preferably has a sufficiently long interaction length Lᵢ₂ so that all or part of the light wave can be transferred from the second guide to the transfer element and vice versa through this second pattern. The optimum interaction length Lₛ₂ corresponds to maximum transfer of the light wave, and in some cases this can mean the transfer of the entire light wave.

The value of the optimum length Lₛ₂ depends on dₛ₂.

Firstly, the values of Lₛ₁ and Lₛ₂, and secondly the values of dₛ₁ and dₛ₂ are not necessarily the same, since these values depend particularly on the characteristics of the first and second guides.

The first and second faces of the transfer element may have variable arrangements depending on the application. For example, the first and second faces may be parallel to each other, particularly when the first and second components are guided optical components. The first and second faces may also be perpendicular to each other, particularly when the first component is a guided optical component and the second optical component is an unguided optical component. Other arrangements could also be considered.

In an embodiment of the invention, the transfer element can also comprise at least one light wave orientation element capable of orienting the light wave from the first pattern to a predetermined area of the second face, in the transfer element.

According to an embodiment of the invention, in which the transfer element comprises a second pattern, the predetermined area of the second face corresponds to the second pattern, the orientation element being capable of orienting the light wave from the first pattern to the second pattern.

According to another embodiment of the invention, the orientation element is formed for example by a cavity made in the transfer element. The cavity comprises at least one wall capable of reflecting the light wave in the transfer element.

A reflective layer can be arranged at least on the wall in order to improve reflection on the wall.

According to an embodiment of the invention, the wall of the orientation element is inclined by an angle φ with respect to a first axis perpendicular to the first face of the transfer element. The light wave passes through the orientation element making an angle θ₁ with the first axis on the first face and an angle θ₂ with an axis perpendicular to the second face of the transfer element on the second face, at a given wavelength. These different angles are related by the relation φ=(θ₂-θ₁)/2, where θ₂=Asin(neff₂/nₘ) and θ₁=Asin(neff₁/nₘ) and neff₁ and neff₂ are the effective indexes for this wavelength in the first and second components, respectively.

According to an embodiment of the invention, when the transfer element does not have an orientation element, for a given wavelength, the light wave passing through the transfer element makes an angle θ₁ with a first axis perpendicular to the first face of the transfer element, at the first face, and an angle θ₂ with an axis perpendicular to the second face of the transfer element, at this second face. These different angles are such that θ₂=θ₁ when the first and second faces are parallel and neff₂=neff₁, where neff₁ and neff₂ represent the effective indexes for this wavelength in the first and second components, respectively.

According to an embodiment of the invention, the transfer element comprises bearing areas on at least the first face of the transfer element. The bearing areas are in contact with the first optical component. These bearing areas, in particular, maintain the transfer element on the first optical component while keeping a distance d_{g1} between the coupling/decoupling pattern and the first optical component, and a distance h₁ between the element outside the pattern and the first optical component.

According to another embodiment of the invention, in which the second optical component is a guided optical component, the second face of the transfer element also comprises bearing areas in contact with the second optical component. In the same way as described above, these bearing areas in particular keep the transfer element on the second optical component while maintaining a distance d_{g2} between the coupling/decoupling pattern and the second optical component, and a distance h₂ between the element outside the pattern and the second optical component.

Another aspect of the invention is to provide a process for making the transfer element from a substrate that is transparent to at least one of the wavelengths of the light wave to be transferred, the substrate having a refraction index greater than the largest of the effective indexes associated with the light wave at least for one wavelength, when the light wave propagates in the first and second components. The process comprising:
depositing a protective layer on at least one area of the substrate, each protective area of the substrate corresponding to a coupling/decoupling pattern to be made,
oxidizing thermally the substrate so as to form a thick oxide layer in areas not protected by a protective layer,
eliminating the oxide layer and the protective layer so as to expose the coupling/decoupling pattern(s) located under the protective layer.

In an embodiment of the invention, the dimensions of the protected areas are approximately equal to the dimensions of the coupling/decoupling patterns.

When the second component is an unguided optical component, an anti-reflection layer may be deposited on the second face of the transfer element.

In an embodiment of the invention, the transfer element comprises bearing areas that are made in the same way and preferably at the same time as the coupling/decoupling patterns. The only difference between these areas and the patterns is their dimensions, since they only perform a mechanical role.

Specifically, when the transfer element comprises bearing areas, during the deposition of the protective layer, the protective layer is also deposited on supplementary areas, each supplementary area corresponding to a bearing area, and the bearing areas are exposed during the elimination of the protective layers.

If the transfer element comprises at least one element for orientation of the light wave formed by a cavity, the manufacturing process according to the invention further comprises:
forming a mask on one of the two faces of the substrate protecting the substrate except for an area of the substrate corresponding to the pattern of the cavity to be made,
etching the substrate through the mask, by preferential chemical attack so as to form the cavity, the cavity having at least one wall capable of orienting the light wave,
eliminating the mask.

According to an embodiment of the invention, a reflective layer is deposited at least on the wall.

In an embodiment of the invention, the process may be terminated by thermal oxidation of the transfer element which is provided with coupling/decoupling pattern(s) and possibly provided with bearing areas, in order to obtain a perfectly controlled distance d_{g1} and/or d_{g2}.

Furthermore, a medium can be placed between the transfer element and the first pattern and/or the second pattern comprising a layer of material. The layer of material is obtained by depositing the material over the entire first face and/or the entire second face of the transfer element, followed by planarization until the pattern(s) is (are) exposed.

In an embodiment, a substrate with a high refraction index is preferably chosen for the transfer element, to give coupling/decoupling with a wide range of optical components. For example, a silicon substrate could be chosen in which the refraction index is about 3.45 for a wavelength λ=1.55 μm; silicon is particularly attractive since it can also be used to make the orientation element by preferential chemical attack.

Obviously, other materials could also be used such as AsGa, InP, CdTe, ZnTe, GaP, particularly for light waves with wavelengths less than 1.2 μm.

Other special features and advantages of the invention will become clearer after reading the following description with reference to the figures in the attached drawings. This description is given for illustrative purposes and is in no way limitative.

### BRIEF DESCRIPTION OF THE DRAWINGS

In the accompanying drawings:

FIGS. 1a and 1b illustrate a conventional method of transferring a light wave between two components;

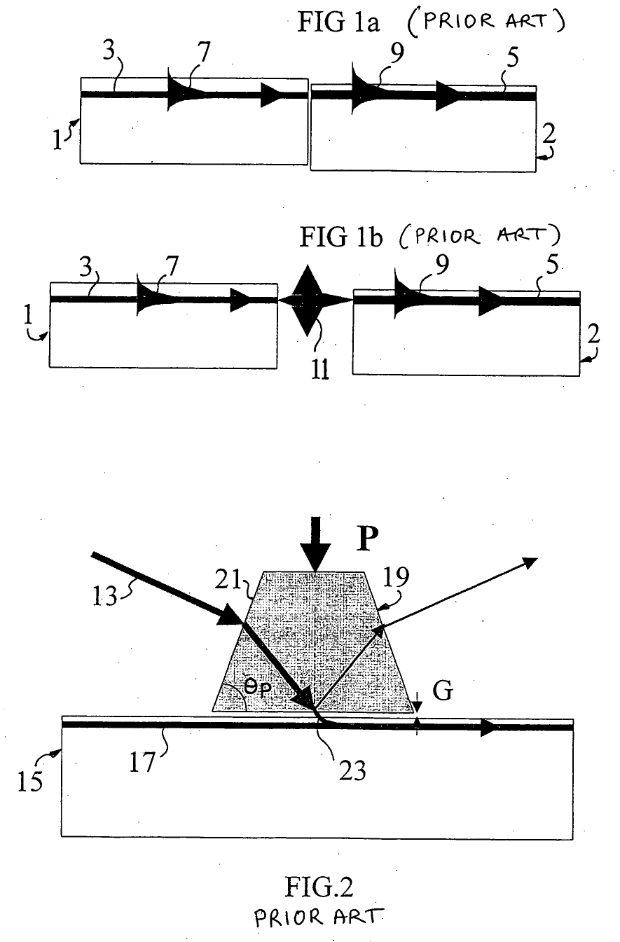

FIG. 2 shows another conventional method of transferring a light wave from free space to an optical component, guided through a prism;

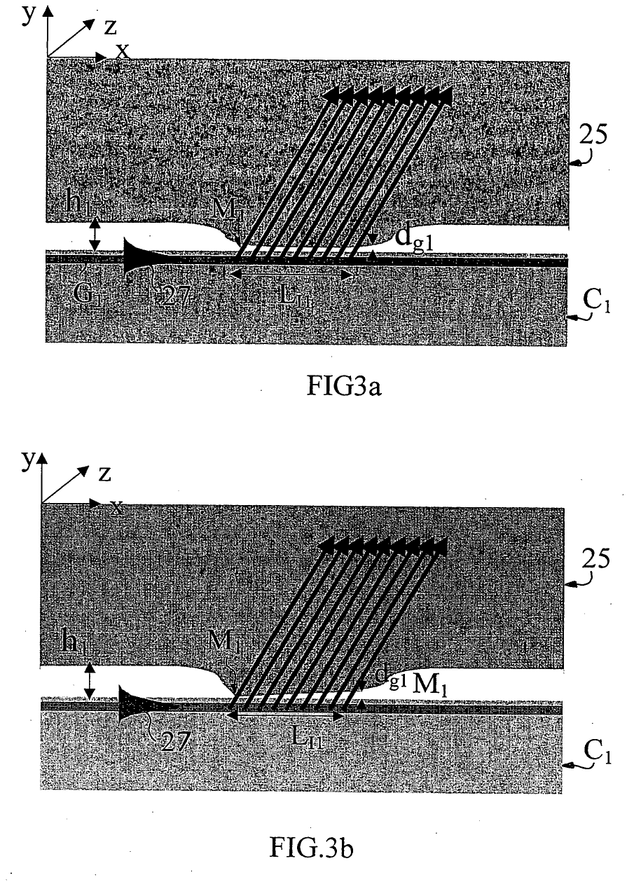

FIGS. 3a and 3b diagrammatically show the transfer principle between a transfer element and a guided optical component according to an embodiment of the invention;

FIG. 4 shows a transfer element capable of transferring a light wave between two guided optical components, according to an embodiment of the invention;

FIGS. 5a, 5b and 5c illustrate a transfer element comprising an orientation element capable of transferring a light wave between two guided optical components, according to the various embodiments of the invention;

FIG. 6 illustrates a transfer element comprising an orientation element capable of transferring a light wave from a guided optical component to an unguided optical component, according to an embodiment of the invention; and

FIGS. 7a to 7g show different steps in an exemplary implementation of a transfer element according to the invention.

### DETAILED DESCRIPTION OF THE INVENTION

For simplification reasons, light guides in all of the attached figures are considered as being the cores of the guides. Consequently, guides are only represented by one layer corresponding to the core of the guides. Furthermore, to make the description clearer, the invention is described for transferring a light wave at a single wavelength, although the light wave could have several wavelengths.

The invention is particularly applicable in the field of optical telecommunications, optoelectronics and optical instrumentation.

An optical component means either an all optical component or an optoelectronic component or in general any component with at least one optical input and/or output. This component may equally be a guided optical component such as an integrated optical component or an unguided optical component such as free space, in which one or several optical components can be combined (for example one or more lenses, one or more mirrors, one or more detectors, one or more guided optical components, etc.). The integrated optical components may also be made of different structures. Examples include optical guides made of III-V semiconductors on InP, particularly suitable for laser sources, detectors, modulators, lithium niobate guides particularly suitable for hyperfrequency modulators, non-linear optical components, silica on silicon guides or guides made by ionic exchange on glass.

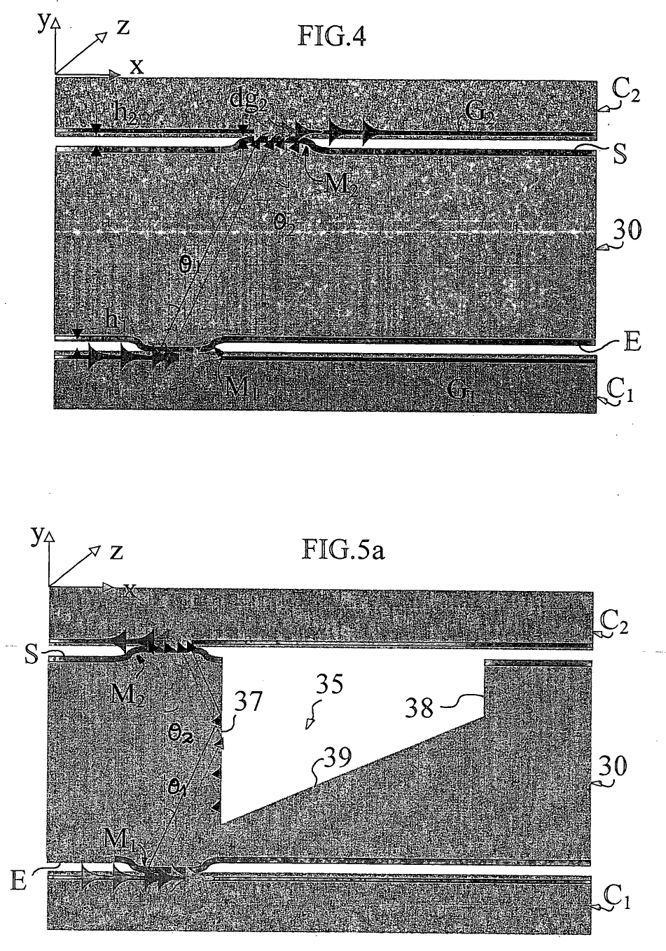

FIGS. 3a and 3b diagrammatically show the principle for transfer of a light wave between a transfer element 25 according to an embodiment of the invention, and a cross-section of a guided optical component C1 in an xy plane. The transfer element 25 and the component C1 are only shown partially in these figures. The cross-section displays a single coupling/decoupling pattern M1 of the transfer element 25 above a light guide G1 of the component C1. The guide G1 is either a planar guide or a microguide. It carries a light wave represented by its propagation profile 27 in the guide. For example, this wave comprises a wavelength associated with an effective index neff₁ in the guide.

The transfer element 25 is transparent to at least the wavelength of the light wave and has a refraction index nₘ greater than neff₁ (in the case of a light wave with several wavelengths, the element 25 must be transparent at least to one of these wavelengths and have a refraction index larger than the largest of the effective indexes associated with this or these wavelengths in the guide).

The coupling/decoupling pattern M1 is located facing part of the optical guide G1 of the component C1.

Two conditions need to be satisfied to enable transmission of the light wave from guide G1 to the transfer element 25 (or vice versa), through the pattern M1:
Firstly, in the area in which interaction takes place, the distance d_{g1} between the pattern M1 and the component C1 needs to be minimized such that the light wave in the guide G1 reaches the pattern M1 with sufficient intensity, through the evanescent wave (of the guided modes(s) in the case of several wavelengths). This distance d_{g1} must be less than a threshold distance dₛ₁ above which no light wave can be transferred from the component C1 to the transfer element and vice versa. The distance d_{g1} determines the coupling/decoupling strength between the wave guide G1 and the transfer element 25 and determines the optimum interaction length Lₛ₁ corresponding to the length necessary for the maximum amount of guided light to be transferred into the transfer element (or vice versa) through the pattern M1.

Therefore, in order to have the maximum light energy transferred through the evanescent wave, from the guide G1 to the transfer element through the pattern M1, the pattern is selected to have an interaction length Lᵢ₁ equal to or close to the optimum length Lₛ₁. When coupling occurs, if the length Lᵢ₁ is less than or greater than Lₛ₁, then a smaller proportion of the light energy will be transferred. In the case of decoupling, as the interaction length increases, a larger part of the light energy is transferred. The optimum length Lₛ₁ then corresponds to the length for which it is considered that the largest part of the light energy (for example 95% or 99% depending on which criterion is chosen) is transferred through the pattern.

The distance d_{g1} and the length Lᵢ₁ are optimized so that the light wave is transferred according to a determined intensity profile.
In the areas in which interaction is to be avoided, which corresponds to the remainder of the transfer element located facing the component, outside the coupling/decoupling pattern, the distance h₁ between the element and the component is selected to be greater than or equal to the threshold distance dₛ₁.

The value of dₛ₁ depends on the different media placed between the transfer element 25 and the guide G1. It may be constant or variable. For example, the value of dₛ₁ will be smaller when the core of the guide G1 is buried.

Furthermore, the medium inserted between the component and the transfer element may be a fluid (for example air) and/or a layer of material (for example a dielectric). The distance dₛ₁ will become smaller as this refraction index becomes smaller.

In order to simplify the description of the figures, we will assume that there is an air film between the transfer element and the component C1.

FIG. 3a shows an embodiment of the transfer element in which the distance d_{g1} is constant along the entire length of the pattern M1 and FIG. 3b shows an embodiment of the transfer element in which the distance d_{g1} is variable along the x axis. h₁ is constant in these two figures.

In particular, the use of a variable value d_{g1} optimizes either decoupling, for example in order to obtain a required intensity profile (Gaussian, stepped, etc.), or coupling, for example to obtain the highest possible coupling efficiency, possibly up to 100%.

This transfer principle may be applied to two integrated optical components.

The parameters necessary for transferring light from component C1 to the transfer element may be determined so as to enable transfer of light from the transfer element to a component C2 (or vice versa).

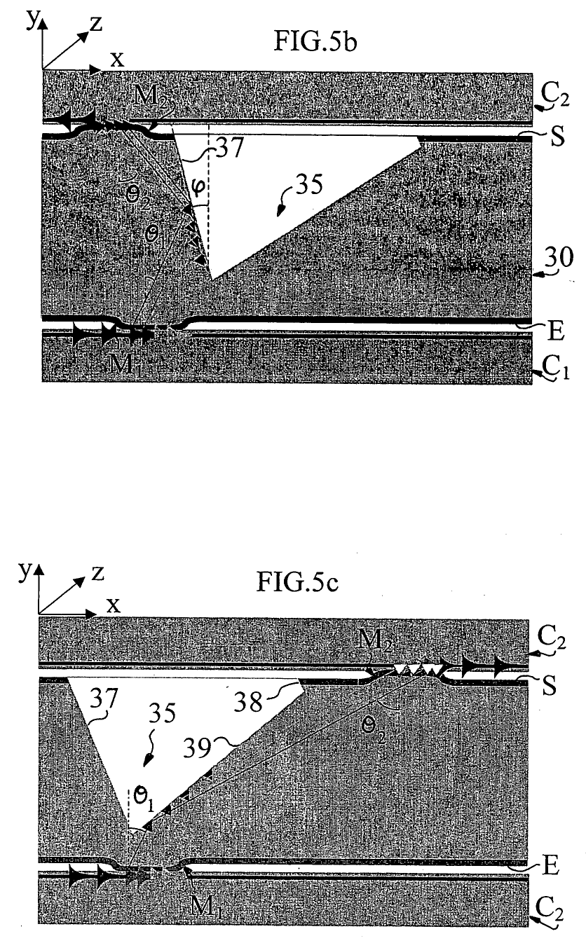

FIG. 4 illustrates a cross-section along a yz plane, showing an example in which a transfer element 30 according to the invention is inserted between two integrated optical components reference C1 and C2 respectively, to enable transfer of the light wave from guide G1 of the component C1, to guide G2 of component C2. Light can be transferred from guide G2 to guide G1 in the same way.

In this example, the transfer element comprises two coupling/decoupling patterns M1 and M2 located facing the guides G1 of component C1 and guide G2 of component C2, respectively. Thus, the face reference E of element 30 comprises the pattern M1 and the face E faces component C1. The face S of this element 30 comprises the pattern M2 and the face S faces component C2.

In this example, the two faces E and S are parallel to each other and to an xz plane.

As described above, the distance d_{g1} between the end of pattern M1 and the guide G1 and the distance d_{g2} between the end of pattern M2 and the guide G2, are such that the light wave can move from one guide to the other through the transfer element. The distance h₁ from the remainder of the transfer element to component C1 and the distance h₂ from the remainder of the transfer element to component C2 are such that the light wave cannot be transferred, as was described above.

The light wave is transferred from guide G1 to element 30 at an angle θ₁ with respect to a y axis perpendicular to face E.

Similarly, the light wave arrives at pattern M2 before being transferred to guide G2 at an angle θ₂ from the y axis perpendicular to the S face. The angles θ₁, θ₂, depend on the refraction index nₘ of the material of element 30 and effective indexes neff₁ and neff₂ for the considered wavelength of the light wave in components C1 and C2 respectively.

Since the two faces E and S are parallel, the angles θ₁ and θ₂ are identical, and the effective indexes neff₁ and neff₂ are also identical.

In this example, and in the following examples, the face E was chosen as the input face in the transfer element and the face S was chosen as the output face from the light wave, to facilitate the description. However, it would have also been possible to consider the reverse. Furthermore, it was chosen to make the E and S faces parallel to each other and to the xz plane for illustration purposes. However, these two faces could also have been at an angle from each other, for example at an angle of 90°.

It is also particularly advantageous to be able to orient the light wave in the transfer element so that the area at which the light wave is output from element 30 can be chosen.

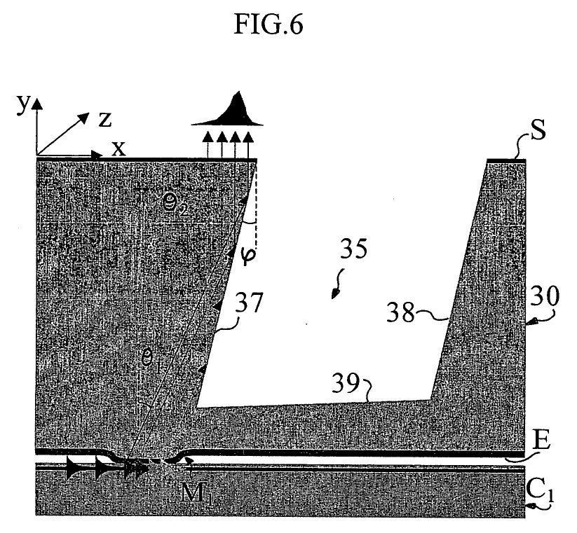

Thus, FIGS. 5a to 5c show a section along a xy plane illustrating exemplary embodiments of a transfer element 30 according to an embodiment of the invention comprising an orientation element 35 capable of orienting the light wave of the input pattern M1 with the output pattern M2 in the transfer element.

This orientation element is made by a cavity with three walls 37, 39 and 38, and at least one of the walls 37 reflects the light wave output from the input pattern M1 to an output area in this example corresponding to pattern M2.

In FIG. 5a, the wall 37 makes an angle φ=0 with the y axis perpendicular to the input face E and the output face S of the transfer element. The light wave introduced by the pattern M1 in the transfer element at an angle θ₁ from the y axis is reflected on the wall 37 such that the light wave arrives at the same angle θ₂b =θ₁ with respect to the y axis on pattern M2, the E and S faces being parallel in this example.

In order to improve reflection from the wall 37, a reflective layer (not shown) is deposited in the cavity at least on the wall 37 when reflection conditions do not correspond to total reflection conditions.

A transfer element with a cavity 35 is shown in FIG. 5b, and in this example there is a wall 37 inclined at a non-zero angle φ with respect to the y axis.

Similarly, a reflective layer (not shown) is deposited in the cavity at least on wall 37, in order to improve reflection of the wall 37.

In this example, the angle θ₂ at which the light wave arrives on the pattern M2 is not equal to θ₁.

In general, the different angles are related by the relation φ=(θ₂−θ₁)/2. φ is positive if θ₂>θ₁ and φ is negative if θ₂<θ₁ where θ₂=Asin (neff₂/nₘ) and θ₁=Asin (neff₁/nₘ). neff₁ and neff₂ are the effective indexes of the modes guided in guide G1 and in guide G2, respectively.

As we have already seen, the special case θ₂=θ₁ corresponds to the case in which the guide G1 and the guide G2 have the same effective indexes.

For example, the result for a wavelength equal to 1.55 μm, for a guide G1 made by ionic exchange in glass with neff₁=1.52, for a guide G2 made by a stack of silica/doped silica/silica with neff₂=1.46 and for a transfer element with refraction index nₘ=3.45 (corresponding to the refraction index of silicon), is θ₁=26.1°, θ₂=25° and φ=−0.65°.

In these conditions, the face E of the transfer element is substantially orthogonal to the wall 37.

FIG. 5c describes a variant embodiment of the transfer element according to another embodiment of the invention, in which the orientation element 35 also comprises a cavity but in this variant embodiment, another wall reference 39 of the cavity reflects the light wave.

Thus, the wall of cavity 35 used to reflect the light wave may be chosen as a function of the values of angles θ₁ and θ₂ and along the entry and exit areas chosen in element 30.

Furthermore, the length in the xy plane of the walls in the cavity may be variable depending on the value of the angle φ and the cavity depth.

As has already been mentioned, one of the components may be an unguided optical component such as free space. In this case, the light wave passes from an integrated optical component to free space or vice versa.

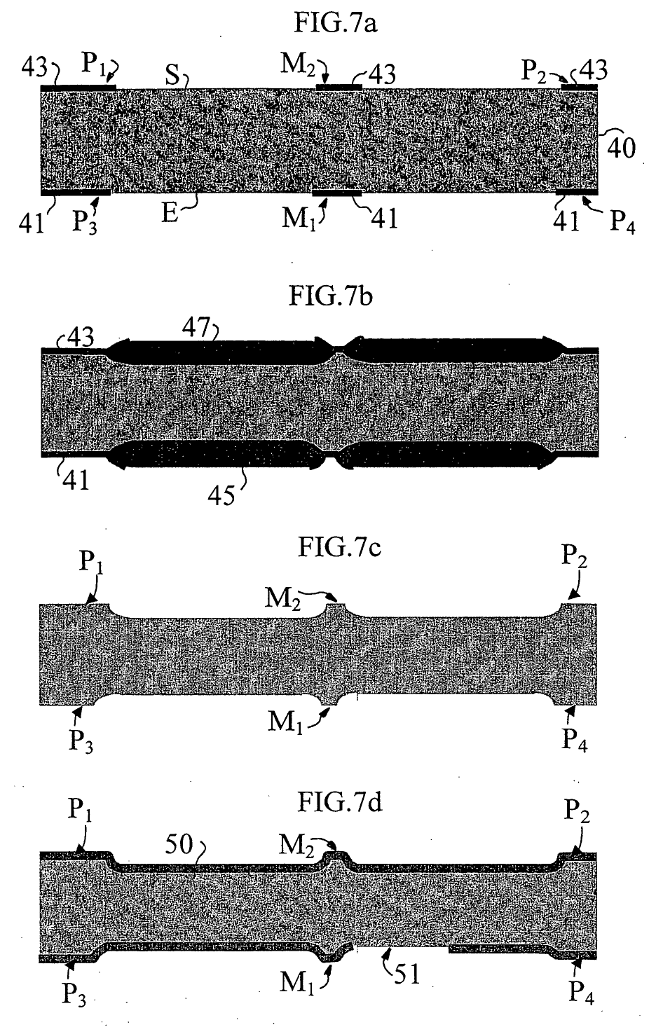

FIG. 6 shows an example of a transfer of the light wave between an integrated optical element C1 and free space, through an element 30 according to an embodiment of the invention. One or several optical elements (not shown) can be combined in the free space.

The element 30 comprises a pattern M1 to enable the light wave in component C1 to pass to the element 30, in the same way as described above.

One of skill in the art would appreciate that the reverse is also possible.

Furthermore, in this example, the transfer element 30 comprises an orientation element 35 formed as above by a cavity comprising three walls references 37, 38 and 39.

In this example, the lateral walls correspond to walls 37, 38 and the bottom of the cavity to wall 39.

The wall 37 in this example enables the light wave output from component C1 to be reflected to free space. In this figure, the angle φ between wall 37 and the y axis is such that the reflected light wave makes an angle θ₂=0 and exits from the element 30 perpendicular to the face S of the said element.

For example, the result for a wavelength of 1.55 μm, a guide G1 made as described above by ionic exchange in the glass with neff₁=1.52, and a transfer element with refraction index nₘ=3.45, is θ₁=26.1°.

To obtain θ₂=0, the angle of the wall 37 is selected to be equal to:
φε=−θ₁/2=−Asin (neff₁/nₘ)/2 =−13.07°.

Furthermore, if the free space is air, neff₂ corresponds to the propagation index of the light wave for the wavelength considered in air.

An anti-reflection layer (not shown) may be placed on face S of the transfer element, to obtain maximum transmission of the light wave in free space.

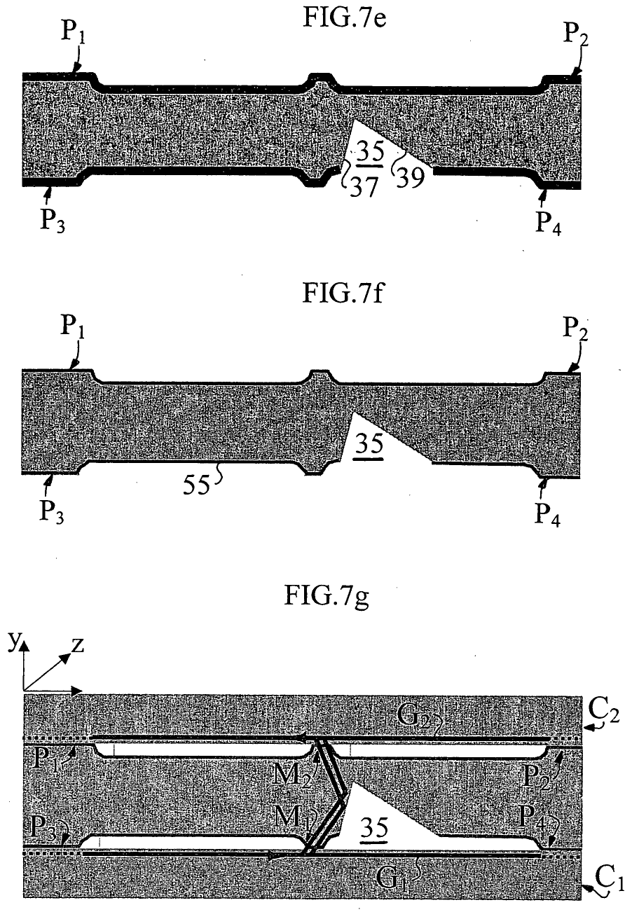

FIGS. 7a to 7g illustrate an exemplary embodiment of a transfer element according to an embodiment of the invention, starting from a substrate transparent to at least one wavelength of the light wave to be transferred and with a refraction index greater than the largest effective index of the light wave for the wavelength(s) considered, in the associated components.

The following process is used to simultaneously make a pattern M1 and pattern M2 on each of the E and S faces of the transfer element that will be facing an optical component.

For example, this process will be described with reference to a silicon substrate 40 and E and S faces parallel to each other.

Starting from substrate 40, a protective layer reference 41 is deposited on the E face and a protective layer reference 43 is deposited on the S face. For example, these layers may be made of Si₃N₄ and for example may be deposited by vapor phase chemical deposition. These layers are then etched, for example by reactive ionic attack using fluorinated gases, so as to leave at least one substrate area corresponding to the coupling/decoupling patterns M1, M2 to be made on each of the faces, covered on each of the faces. In general, bearing areas for the transfer element are provided on each of said faces and are also protected by protective layers 41 and 43. These bearing areas to be made are referenced P1, P2 for the S face and are arranged on each side of the pattern M2 and are referenced P3, P4 for the E face, and are arranged on each side of pattern M1 (see FIG. 7a).

Subsequently, the substrate is thermally oxidized so as to form a thick oxide layer 45 (on the E face) and a thick oxide layer 47 (on the S face), in areas not protected by the protection layers. In the case of a silicon substrate, the oxide layer is a silica layer with a thickness for example of between 1 and 4 μm (see FIG. 7b).

The next step is to eliminate the oxide layers 45, 47 and the protection layers 41, 43 as shown in FIG. 7c, for example by reactive chemical or ionic attack. The coupling/decoupling patterns, M1, M2 and the bearing areas P3, P4 and P1, P2 that are located under the protection layers are then exposed and form prominences on the E and S faces respectively projecting beyond the remaining part of these faces that were partially consumed by thermal oxidation and which are consequently set back.

When the transfer element comprises an orientation element, the process for implementation of the invention continues by making a mask 50 (see FIG. 7d) on the E and S faces protecting the substrate except for an area 51 starting from which the process according to an embodiment of the invention will make a cavity to form this orientation element. For example, this mask 51 may be formed by deposition of a silica layer or a thermal oxidation layer, and this layer will then be eliminated in area 51 only, for example by reactive chemical or ionic etching through an intermediate mask, not shown.

FIG. 7e shows the next step corresponding to production of the cavity 35. During this step, the substrate is etched through the mask 50. This etching is performed by preferential chemical attack (for example with KOH, or pyracathecol diethylamine) to obtain a prismatic-type cavity. In other words, the walls 37 and/or 39 have a determined orientation from the y axis, depending on the crystallographic planes of the silicon substrate. For example, for an E face oriented along a [1,1,0] plane, this preferential chemical attack will result in a wall 37 with an orientation perpendicular to the E face and parallel to the y axis and a wall 39 making an angle equal to 19.48° with the x axis (or 70.52° with the y axis).

At this stage, a reflecting layer (not shown) may be deposited on at least the wall of the cavity that will enable reflection of the light wave to improve reflectivity of the wall. This reflecting layer may, for example, be a layer of gold deposited by evaporation or cathodic sputtering.

The next step is to eliminate the silica mask 50, for example by selective reactive ionic type etching using fluorinated gases (see FIG. 7f). Elimination of this mask removes the deposit of the reflecting layer, if any, on the E and S faces.

It may be advantageous to form a material layer 55 by deposition or thermal oxidation of the faces with patterns, to have perfect control over the parameters d_{g1} and d_{g2} between the patterns M1 and M2 and components C1 and C2.

In this exemplary embodiment, the patterns obtained are prominent above the rest of the substrate that is set back. However, as described above, the medium inserted between the transfer element and the components may be a material layer with an appropriate refraction index and thickness to prevent coupling/decoupling of the light wave. This layer may be deposited firstly on the E and S faces on each side of the patterns M1 and M2. In these conditions, the bearing areas may no longer be necessary if the thickness of this material is such that the distances d_{g1}, d_{g2} can be preserved.

For example, this layer may be SiO₂ or MgFr or more generally any material with a fairly low refraction index. This layer may be deposited by evaporation or cathodic sputtering.

FIG. 7g represents the final step of the process that consists of assembling the transfer element obtained in step 7f with two integrated optical components C1 and C2 that comprise guides G1 and G2 respectively.

This assembly may be made by any known means and for example by molecular bonding techniques. Thus, the S face is linked to component C2 through inter-atomic bonds and the E face is also linked to component C1 by inter-atomic bonds.

Guides G1 and G2 may be more or less buried in the components; parameters dₛ₁, dₛ₂ take account of this.

In FIG. 7g, the bearing areas P1, P2, P3, P4 are represented in the same xy plane as the patterns M1 and M2. Consequently, the parts of the guides G1, G2 located at these bearing areas are shown in dashed lines to signify that they are in different planes from the planes of the bearing areas, and are sufficiently buried to prevent any interaction with these areas.

According to another embodiment of the invention, it would also have been possible to make these bearing areas in planes different from the planes containing the patterns M1, M2 to avoid any interaction with the component guides G1 and G2.

Furthermore, in FIGS. 7a to 7g, the patterns M1, M2 are such that the values d_{g1}, d_{g2} are constant. As discussed above, it can be advantageous to have variable values of d_{g1} and/or d_{g2}. To achieve this, the process according to the invention as described with reference to these figures is modified slightly to obtain patterns M1 and/or M2 with variable thickness in the xy plane and/or possibly in the yz plane.

For example, these modifications consist of forming a variable thickness protection layer 41, 43 on the substrate areas corresponding to the patterns M1 and M2 such that when the thermal oxidation step is carried out, the substrate oxidizes outside the protection layers and oxidizes partially at the protection layers, under the parts of the protection layers that are not thick enough to completely protect the substrate. Since the thicknesses of layers 41 and 43 are variable, the thickness of this oxidation is also variable and partially consumes the patterns, so that the result after the protection layers and thermal oxidation layers have been eliminated is patterns that also have variable thicknesses.

The manufacturing process that has just been described is used to make a transfer element for two components with integrated optical. One of ordinary skill in the art would appreciate that the same manufacturing steps may be carried out on only one of the faces of the substrate to make a transfer element adapted to a component with integrated optical and to a component in free space.

Furthermore, the description has been made based on one pattern for each face of the transfer element. However, for some more complex applications, there could be several transfers between the transfer element and the same component and therefore several patterns on the same face of the element.

1. A transfer element comprising:
a first face and a second face, said first face is arranged to face at least a part of a first optical component comprising at least a first optical guide, and said second face is arranged to face at least a part of a second optical component;
a first coupling/decoupling pattern, said first coupling/decoupling pattern being arranged on said first face which faces at least a part of the first optical component,
wherein said transfer element transfers a light wave comprising at least one wavelength, from one of said first optical component and said second optical component to the other one of said first optical component and said second optical component,
wherein said transfer element is transparent to said at least one wavelength of the light wave and said transfer element has a refraction index greater than a largest of effective indexes at least at said wavelength when the light wave propagates in the first optical component and in the second optical component, and
wherein said first coupling/decoupling pattern is separated from said first optical component by a distance d_{g1} less than a threshold distance dₛ₁ above which no light wave can be transferred between the first optical component and the transfer element.

2. A transfer element according to claim 1, wherein the distance d_{g1} is variable.

3. A transfer element according to claim 1, wherein outside the first coupling/decoupling pattern, a part of the first face which faces the first guide is at a distance h₁ from the first component, said distance h₁ being greater than or equal to the threshold distance dₛ₁.

4. A transfer element according to claim 1, further comprising a medium placed between the first face of the transfer element and the first component.

5. A transfer element according to claim 4, wherein said medium includes any one of a fluid, a layer of material and a combination thereof.

6. A transfer element according to claim 1, wherein the first pattern has an interaction length Lᵢ₁ substantially equal to the optimum length Lₛ₁, for maximum transfer of the light wave.

7. A transfer element according to claim 1, wherein the second component is an unguided optical component and the second face of the transfer element comprises an anti-reflection layer on at least the area of said face through which the light wave passes.

8. A transfer element according to claim 1, further comprising a second coupling/decoupling pattern on the second face of said transfer element,
wherein the second component is a guided optical component comprising at least a second optical guide, facing a part of the second guide,
wherein the second coupling/decoupling pattern is separated from said second component by a distance d_{g2} less than a threshold distance dₛ₂ above which no light wave can be transferred from the second component to the transfer element and vice versa.

9. A transfer element according to claim 8, wherein the distance d_{g2} is variable.

10. A transfer element according to claim 8, wherein apart from the second coupling/decoupling pattern, the part of the second face facing the second guide is at a distance h₂ from the second component greater, said distance h₂ being less than the threshold distance dₛ₂.

11. A transfer element according to claim 8, further comprising a medium located between the second face of the transfer element and the second component.

12. A transfer element according to claim 11, wherein said medium includes any one of a fluid, a material layer and combination thereof.

13. A transfer element according to claim 8, wherein the second pattern has an interaction length Lᵢ₂ substantially equal to an optimum interaction length at which maximum transfer of the light wave takes place.

14. A transfer element according to claim 1, further comprising at least one orientation element,
wherein said orientation element is capable of orienting the light wave from the first pattern to a predetermined area of the second face of the transfer element.

15. A transfer element according to claim 14, wherein the predetermined area of the second face corresponds to the second pattern.

16. A transfer element according to claim 14, wherein the orientation element is formed by a cavity made in the transfer element, and the cavity includes at least one wall which is reflective to the light wave in the transfer element.

17. A transfer element according to claim 16, wherein said wall has a reflective layer formed thereon.

18. A transfer element according to claim 16, wherein:
said wall of the orientation element is inclined by an angle φ with respect to a first axis perpendicular to the first face of the transfer element,
the wave passing through said element makes an angle θ₁ with said first axis on the first face of the transfer element and makes an angle θ₂ with an axis perpendicular to the second face of the transfer element on the second face of the transfer element, for a given wavelength,
the angle θ₁ and the angle θ₂ are related by the relation φ=(θ₂−θ₁)/2,
where θ₂=Asin(neff₂/nₘ) and θ₁=Asin(neff₁/nₘ) and neff₁ and neff₂ are the effective indexes for the given wavelength in the first and second components, respectively.

19. A transfer element according to claim 1, wherein the first and the second faces of the transfer element are parallel, for a given wavelength.

20. A transfer element according to claim 19, wherein the light wave which passes through said transfer element makes an angle θ₁ with a first axis perpendicular to the first face, and an angle θ₂ with an axis perpendicular to the second face,
the angles θ₁ and θ₂ are such that θ₂=θ₁ and neff₂=neff₁,
where neff₁ and neff₂ represent the effective indexes at said given wavelength in the first and second components, respectively.

21. A transfer element according to claim 1, further comprising:
bearing areas on at least one of the first face and the second face,
wherein said bearing areas are in contact with at least one of the first component and the second component.

22. A process for making a transfer element from a substrate that is transparent to at least one wavelength of the light wave to be transferred, said substrate having a refraction index greater than the largest of the effective indexes associated with the light wave at least at said one wavelength, when said light wave propagates in a first component and a second component of said transfer element, said transfer element having a first face and second face, the process comprising:
depositing a protective layer on at least one area of the substrate to form a protected area in the substrate, said protected area corresponds to a coupling/decoupling pattern to be formed;
oxidizing thermally the substrate to form a thick oxide layer in areas not protected by the protective layer; and
eliminating the oxide layer and the protective layer to expose the coupling/decoupling pattern located under the protective layer.

23. A process for making a transfer element according to claim 22, further comprising:
depositing an anti-reflection layer on the second face of the transfer element.

24. A process for making a transfer element according to claim 22, further comprising:
depositing a protective layer on supplementary areas, each supplementary area corresponding to a bearing area of the transfer element; and
exposing said supplementary areas by eliminating the protective layer on said supplementary areas.

25. A process for making a transfer element according to claim 22, further comprising:
forming a mask on one of the first and second faces of the substrate;
protecting the substrate except an area of the substrate corresponding to the pattern of a cavity of an orientation element in the transfer element;
etching the substrate through the mask, by preferential chemical attack so as to form said cavity, said cavity having at least one wall capable of orienting the light wave; and
eliminating the mask.

26. A process for making a transfer element according to claim 22, further comprising depositing an anti-reflection layer at least on said wall.

27. A process for making a transfer element according to claim 22, further comprising oxidizing thermally the transfer element.

28. A process for making a transfer element according to claim 22, further comprising:
depositing a material over at least one of the entire first face and the entire second face of the transfer element; and
planarizing said material until the coupling/decoupling pattern is exposed.

29. A process for making a transfer element according to claim 22, wherein the substrate comprises silicon.

30. A process for making a transfer element according to claim 22, further comprising assembling the transfer element with at least one of the first and the second component by molecular bonding.

31. An optical system comprising:
a first optical component comprising at least a first optical guide;
a second optical component; and
a transfer element comprising:
a first face and a second face, said first face is arranged to face at least a part of said first optical component comprising at least the first optical guide, and said second face is arranged to face at least a part of said second optical component;
a first coupling/decoupling pattern, said first coupling/decoupling pattern being arranged on said first face which faces at least a part of the first optical component,
wherein said transfer element transfers a light wave comprising at least one wavelength, from one of said first optical component and said second optical component to the other one of said first optical component and said second optical component,
wherein said transfer element is transparent to said at least one wavelength of the light wave and said transfer element has a refraction index greater than a largest of effective indexes at least at said wavelength when the light wave propagates in the first optical component and in the second optical component, and
wherein said first coupling/decoupling pattern is separated from said first optical component by a distance d_{g1} less than a threshold distance dₛ₁ above which no light wave can be transferred between the first optical component and the transfer element.
